(19) United States
(12) Patent Application Publication
(10) Pub. No.: US 2008/0055478 A1
(43) Pub. Date: Mar. 6, 2008

(54) Maintenance Of Hue In A Saturation-Controlled Color Image

(75) Inventor: Cornelis Antonie Maria Jaspers, Hapert (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,577

(22) PCT Filed: Jul. 14, 2005
(86) PCT No.: PCT/IB05/52337

§ 371 Date: Jan. 24, 2007

(30) Foreign Application Priority Data
Jul. 27, 2004 (EP) 04103585.8

(51) Int. Cl. H04N 9/68

(52) U.S. Cl. 348/645; 348/E09.053

(57) ABSTRACT

A hue error may occur upon a saturation control CSC if for a given pixel not only the color becomes more saturated but also the color of pixel changes. In a first variant the invention proposes to predict the saturated color after a saturation increase by applying in a first processing stream (23) an estimated gamma-function of a display device (11) to the saturated signal (Y′, satx(R′−Y′), satx(B′−Y)) thus obtaining a saturated color and in a second processing stream (25) to the original signal (Y′, (R′−Y), (B′−Y)) thus obtaining the original color. The saturated color is corrected to the original color, while maintaining its increased saturation. In a second variant predicting the hue of the output of the display becomes unnecessary by offering a hue correction (35) after the color saturation control (17) when negative color contributions happen. In a third variant it is possible to apply a color difference signal after the color saturation control (17) to empirically approximate the hue correction.

### FIELD OF THE INVENTION

The present invention relates to an image signal processing method of controlling a color saturation for an image, and a respective image signal processing device, apparatus, computer program product.

Contemporary image signal processing techniques usually have to apply specific control means to control a hue or a saturation or a lightness of an image upon image signal processing to avoid abnormal or exaggerated image parameters. In a color display device, the saturation of the colors in the displayed image may be increased by means of a saturation control. When this is done it may happen that for a given pixel or area of pixels not only the color becomes more saturated but also that the color of the pixel changes. This is called a hue error. In the following a hue error may denote any kind of unnatural shifted colors or abnormal tones upon changing a saturation control.

### BACKGROUND OF THE INVENTION

Hue errors of the mentioned kind have not yet been fully addressed by prior art teachings.

The disclosure of U.S. Pat. No. 5,450,217 teaches to re-filter an image to reduce a luminance as a function of the original luminance and the luminance of a saturation enhanced image. However, such teaching does not address hue errors caused by the display at an increasing color saturation control.

Also the teaching of US 2003/0025835 A1 does not address hue errors of the above-mentioned kind. The method is restricted to independently controlling a hue or a saturation of individual colors in a real time digital video image without effecting the hue or saturation of any other color in the same real time digital video image. A control method restricted to an individual color of the mentioned kind is not able to give satisfactory results. A hue maintenance should apply at least for relevant areas or the total 3D-color space.

In U.S. Pat. No. 6,366,291 a color conversion method is disclosed wherein actual chrominance coordinates of colors expressed by fluorescent materials are replaced by virtual chrominance coordinates having the same hues as those of the actual chrominance coordinates but higher saturations than those of the actual chrominance coordinates. The disclosed method prevents a change of hue when a negative color or a color beyond the maximum with reducible value occurs upon transferring an original color image for example from a color film, a color photographic paper or a color print with a color scanner to a color monitor or a display. Indeed the gamut of an original color image or the gamut of a color printed image often includes colors that are located out of the color range which is defined by the fluorescent materials of an RGB color monitor. Also the method of the mentioned kind is able to improve saturation. However, the method is restricted to improve the situation with regard to the gamut of a color printed image and neglects the hue errors which arise from a saturation control as mentioned above. Consequently the mentioned method is able to remove abnormal colors upon a transfer of a color printed image to a color display, however will nevertheless cause hue errors of the above-mentioned kind upon saturation control of the image signal.

Desirable is a concept wherein a hue of a color image is maintained even upon performing a saturation control of the image.

### SUMMARY OF THE INVENTION

This is where the invention comes in, the object of which is to provide an image signal processing method of controlling a color saturation for an image and a signal processing apparatus for controlling a color saturation for an image which effectively prevents hue errors, which arise from changing a saturation for the image to be displayed.

In particular it is a further object of the invention to provide the method and apparatus capable of preventing hue errors in predetermined areas of or the total 3D-color space.

As regards the method the object is achieved by an image signal processing method of controlling a color saturation for an image, the method comprising the steps of:

providing an input image signal;

applying a saturation control to the input image signal resulting in a saturation-controlled image signal; wherein

a hue restoration is applied on basis of the saturation-controlled image signal by:

determining a first hue value from a first image signal in a first processing stream, and

determining a second hue value from a second image signal in a second processing stream;

obtaining a corrected hue value from the first hue value and/or the second hue value;

obtaining an output signal based on the corrected hue value.

It has been realized by the invention, that hue errors occurring upon a saturation control may be effectively prevented only if the hue restoration is applied on basis of the saturation-controlled image signal. Consequently in its basic idea the present invention teaches to determine a first hue value and to determine a second hue value whereupon an output signal is based on a corrected hue value obtained from the first hue value and/or the second hue value. The invention has realized, that a saturation control effects the input image signal in some particular relevant ways, which result in differences between the first hue value and the second hue value. The first and second hue values are chosen in a particular preferred kind. Four variants thereof are described in detail with reference to FIGS. 4, 7, 9 and 10 in the detailed description. The main concept proposed by the invention is to obtain a corrected hue value based on the differences between the first hue value and/or the second hue value.

The above-mentioned concept is based on the perception, that when undoing hue errors also the colors inside the color gamut should be taken into account. In particular the invention has realized that as soon as an inside color supersedes the color gamut due to an increasing color saturation color, the hue error will start increasing as well. Hence it appears that the largest hue errors will happen with the border colors.

Also the invention has realized, that the hue of the colors in-between the primary and the complementary colors are shifting towards the RGB primaries. In particular the largest hue errors happen near the yellow color and the smallest ones near the blue color.

Also the invention has realized that in case of a color saturation control larger than unity negative primary color contributions may arise and may lead to hue errors. The invention has realized, that the main part of these kind of hue errors at an increasing color saturation are caused by the non-linear display transfer function, which on the one hand results in the mentioned shift of colors and on the other hand it limits negative primary color contributions to zero. A non-linear transfer function will be simply referred to as “gamma” or “degamma”.

This concept is in contradistinction to common place measures, which are isolated to certain chrominance coordinates like in US 2003/0025835 or restricted to specific transfer situations like disclosed in U.S. Pat. No. 6,366,291—the latter cannot successfully prevent hue errors.

Furthermore the concept of the present invention may be flexibly adapted in accordance with certain aspects of the invention, which are outlined in the dependent claims.

Preferably the input image signal is formed by a luminance component and a color component, in particular a non-linear luma component and a non-linear chroma component. A color saturation control is executes preferably in the non-linear signal domain.

A first or second hue value is preferably determined as an angle in a 2D-plane of difference coordinates, wherein the difference coordinates are formed by a color component and a luminance component of a first or second image signal. The color components may be formed in either way by a chrominance or chroma value. The calculation is preferably performed by means of a Hue-Calculation function, e.g. in a software-code section. In particular a Hue-Calculation can be preferably performed by means of a suitable hardware component like a computing device.

The output signal is obtained preferably by using the corrected hue value in a trigonometric function. The calculation is preferably performed by means of a Hue-Restoration function, e.g. in a software-code section. In particular a Hue-Restoration function is preferably realized in a suitable hardware component like a computing device.

Preferably a saturation value of the saturation-controlled image signal is maintained in the output signal upon hue restoration.

Further major aspects of the invention will be addressed in the following.

In accordance with a first aspect of the invention it has been realized, that the main reason for all hue errors is the non-linear display transfer function. Consequently in a first variant of the invention the hue restoration is applied on basis of a predicted “after-display transfer function signal”. In the first variant's basic idea the hue restoration is applied in the color space after a simulated display transfer function. This means that a corrected hue value is obtained after prediction of a signal which is characteristic for a display signal, i.e. usually for a linearized signal, e.g. determined by the overall transfer of the input signal and the display. Nevertheless as the camera and display gamma hardly are exactly complementary usually an overall non-linear gamma exists. An advantage of the first variant is, that the results do not depend on the camera gamma.

In a particular preferred configuration the first image signal is formed by the saturation-controlled image signal and the second image signal is formed by the input image signal.

This measure forms the basis to predict a saturated color after a saturation increase on the one hand and obtain the original color on the other hand. In a preferred configuration of this variant the first processing stream comprises the steps of:

transforming the first image signal, in particular the saturation-controlled image signal, into a RGB-image signal, in particular into a saturation-controlled RGB-image signal;

non-linear converting the RGB-image signal into a predicted saturation-controlled RGB-image signal;

re-transforming the predicted saturation-controlled RGB-image signal into a saturation-controlled first image signal.

As a result the predicted image signals may serve to determine the first hue value.

Also in a developed configuration the second processing stream comprises the steps of:

transforming the second image signal into a RGB image signal;

non-linear converting the RGB image signal into a predicted RGB image signal;

re-transforming the predicted RGB image signal into a processed second image signal.

Consequently the second hue value may be determined from the predicted image signals and the re-transformed predicted image signal.

In other words, the first variant of the present invention proposes to predict the saturated color after a saturation increase by applying for instance an estimated gamma-function of the display device to the saturated signal. Also, for instance the estimated gamma-function is applied to the original signal, i.e. the signal without increased saturation thus obtaining the original color. This variant is particular preferred to subsequently correct the saturated color to the original color while maintaining its increased saturation.

In particular after hue restoration a degamma, i.e. an inverse display transfer function is applied to obtain a display signal. Specifically a display signal may be obtained comprising the steps of:

transforming the output signal into an output RGB image signal;

non-linear converting the output RGB image signal into the display signal.

Particularly preferred configurations of the first variant are outlined in the dependent claims 7 to 17.

In accordance with a second aspect of the invention it has been realized, that the display gamma limits negative primary color contributions to zero. Consequently in a second variant of the invention the hue restoration is applied on basis of a “before-display transfer function signal”. This means, that the hue restoration is applied in the color space before a display is simulated, i.e. in the non-linear space between the camera gamma and the display panel. The second variant is based on the perception, that most errors arise because the display gamma limits negative primary color contributions to zero.

In a further developed configuration of the second variant the first image signal and the second image signal is formed by the same saturation-controlled image signal.

In a preferred configuration of the second variant the first processing stream comprises the step of:

determining the first hue value directly from the first image signal, in particular a saturation-controlled image signal.

Most preferably in the second variant the second processing stream comprises the steps of:

transforming the second image signal, in particular a saturation-controlled image signal, into an RGB image signal, in particular a saturation-controlled RGB-image signal;

providing a limited RGB image signal by limiting negative values of the RGB image signal to zero;

re-transforming the limited RGB image signal into a limited second image signal.

Consequently the measures of the second variant of the invention determine a first hue value taking into account negative values and a second hue value by limiting negative values of the RGB image signal to zero. In the latter case a negative color prevention NCP is applied. As a result a corrected hue value can be obtained from the first hue value and/or the second hue value according to the second variant of the invention.

The second variant has the advantage, that a domain conversion by means of non-linear converting an RGB image signal can be avoided by limiting negative colors to zero and taking the hue of the limited signal instead the hue of the original signal. Also here it is guaranteed that the resulting color is corrected to the original color, while maintaining its increased saturation. There is no need to predict the hue of the output of the display as compared to the first variant.

Developed configurations of the second variant of the invention are outlined in the dependent claims 18 to 23.

In accordance with a third aspect of the invention it has been realized, that within an empirical found adaptation as a function of the color saturation control it is possible to apply a color difference signal after the color saturation control and it is possible to approximate the hue correction of the second variant of the invention. Consequently in a third variant of the invention in the hue restoration the corrected hue value is obtained further by means of the non-linear chroma-component of the saturation-controlled image signal. The advantage of this is that the extra amount of processing is limited to the hue correction as such.

Further developed configurations of the third variant of the invention are outlined in the dependent method claims 24 to 26.

To summarize, according to the first variant of the invention the corrected hue value is obtained in particular by further means of a color component of the predicted saturation-controlled RGB image signal.

According to the second variant of the invention the corrected hue value is obtained in particular further by means of a color component of the limited RGB image signal.

According to the third variant of the invention the corrected hue value is obtained in particular further by means of the non-linear chroma-component of the saturation-controlled image signal.

In accordance with a further developed configuration of the invention, in particular to prevent divider problems upon processing, preferably the step of hue restoration is completed as a function of a threshold level of a value of a color component of a RGB image signal. The latter variant is able to apply one or more so called membership-functions to form a hue restoration in preferred and predetermined areas of the 3D-color space. For instance partially a hue correction may be applied above a certain threshold level of a RGB color. Another membership function may be adapted to apply partly or full hue correction only in the outer regions of the 3D-color space, the latter is based on the perception, that the largest hue errors usually happen with border colors. In particular a membership function is applied to prevent inevitable divider problems. A small denominator is in particular prevented by observing difference values of a maximum and a minimum of a RGB value.

The method and developed configurations thereof as outlined above may be implemented by digital circuits of any preferred kind, whereby the advantages associated with digital circuits may be obtained. A single processor or other unit may fulfill the functions of several means recited in the claims or outlined in the description or shown in the figures.

Consequently, with regard to the apparatus, the invention also leads to a signal processing device for controlling a color saturation for an image, said device comprising:

means for providing an input image signal;

means for applying a saturation control to the input image signal resulting in a saturation-controlled image signal; wherein

a hue restoration unit is adapted to process a saturation-controlled image signal, the unit comprising:

means for determining a first hue value from a first image signal in a first processing stream, and

means for determining a second hue value from a second image signal in a second processing stream;

means for obtaining a corrected hue value from the first hue value and/or the second hue value;

means for obtaining an output signal based on the corrected hue.

In particular with regard to the apparatus, the invention also leads to an apparatus comprising a display means and a signal processing device, wherein the signal processing device is adapted to perform the method as mentioned above. In particular a display means may be selected from the group consisting of a cathode ray tube (CRT), liquid crystal display (LCD), plasma display panel (PDP). A display means of the mentioned kind may be used in particular in a camera or in form of a monitor, in particular for a computer or a television.

The invention also leads to a computer program product storable on a medium readable by a computing device comprising a software code section which induces the computing device to execute the method as described above when the product is executed on the computing device. Preferred configurations of software code sections relate to a hue-calculation, a hue-restoration and a membership function.

The invention also leads to a computing and/or a storage device for executing and/or storing the computer program product as described above. In particular a preferred computing device is adapted to perform the above-mentioned hue-calculation, hue-restoration and/or membership functions.

These and other aspects of the invention will be apparent from and elucidated with reference to the preferred embodiments described hereinafter.

It is, of course, not possible to describe every conceivable configuration of the components or methodologies for purposes of describing the present invention, but one of ordinary skill in the art will recognize that many further combinations and permutations of the present invention are possible.

Usually such techniques described above apply for television sets or digital still and video cameras. Whereas the invention has particular utility for and will be described as associated with a display it should be understood that the concept of the invention is also operable with other forms of an output device for outputting color images. For example the concept of the invention may also be applied to a color printer or many computer applications.

Image signal processing meanwhile has become a relevant part of consumer electronics, in particular also digital consumer equipment and all kinds of audio and video front ends and other kinds of information and entertainment products. Such techniques are implemented also in computer software for picture editing as most PC color monitors meanwhile have the same color gamut and non-linear transfer functions as a TV set, because consumer electronics and computer electronics become more and more connected to each other.

### BRIEF DESCRIPTION OF THE DRAWINGS

For a more complete understanding of the invention, reference should be made to the accompanying drawing, wherein:

FIG. 1 is a schematic diagram of a location of the analysis of the color saturation control;

FIG. 2 shows a top projection of level 4′ of the Chroma plane and all levels of the UCS1976 plane with the signal after the camera gamma as a reference;

FIG. 3 shows a CRT output in the 2D UCS1976 and Chrominance” color planes after a saturation control of 1.2;

FIG. 4 is a flow-chart of a first preferred embodiment of the signal processing method, wherein the hue of the display after the saturation control is maintained;

FIG. 5 is a schematic diagram to illustrate the hue restoration with unreduced color difference signals in the 2D Chrominance plane;

FIG. 6 shows results of a hue maintenance as a function of the color saturation control according to the first preferred embodiment of FIG. 4;

FIG. 7 is a flow-chart of a second preferred embodiment of the signal processing method, wherein the hue of the display after the saturation control is maintained without a CRT gamma and a degamma transfer;

FIG. 8 shows results of a hue maintenance as a function of the color saturation control according to the second preferred embodiment of FIG. 7, wherein the hue of the display after the saturation control is maintained without a CRT gamma and degamma transfer, but by preventing negative primary contributions;

FIG. 9 is a flow-chart of a third preferred embodiment of the signal processing method, wherein the hue of the display is maintained with a minimum of processing in the signal path by using the color difference signals after the color saturation control;

FIG. 10 is a flow-chart of a modification of the first preferred embodiment of the signal processing method shown in FIG. 4, wherein the hue of the display after the saturation control is maintained and a membership function is implemented;

FIG. 11 is a graph of a RGBmax′ membership function for hue correction and a RGBmax′ membership function in the 3D Chroma space for use in a preferred embodiment of FIGS. 4, 7 or 9 wherein the hue of the display after the saturation control is maintained;

FIG. 12 is a graph of a (RGBmax′-RGBmin′) membership function for PhiHue calculation and a (RGBmax′-RGBmin′) membership function in the 3D Chroma space, for; use in a preferred embodiment of FIGS. 4, 7 or 9 wherein the hue of the display after the saturation control is maintained.

### DESCRIPTION OF THE PREFERRED EMBODIMENTS

1. Introduction

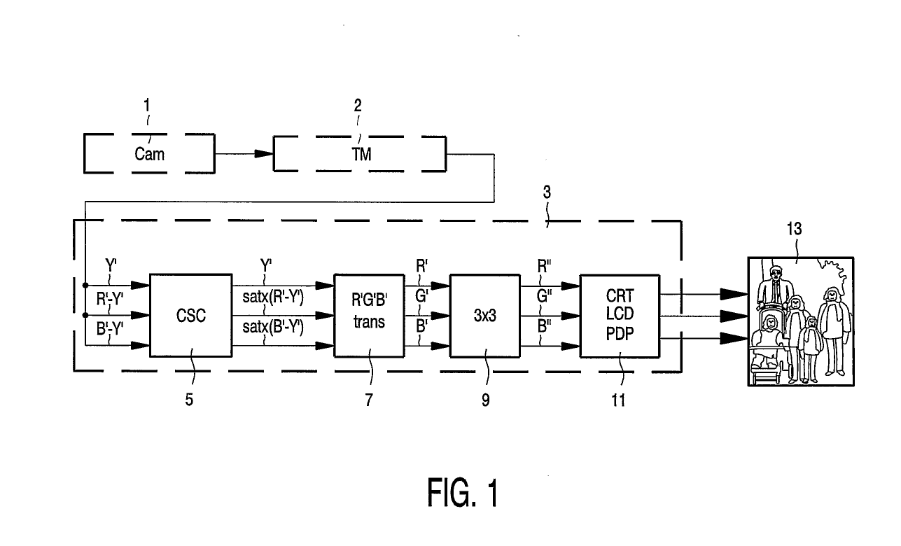

Several methods are described to restore the hue errors at the output of a display apparatus 3 (TV set, monitor, printer, computer, audio/video applications) at an increased color saturation control (i.e. a saturation value “sat” is larger than unity), as shown on FIG. 1.

A color saturation control (CSC) 5 in a display apparatus e.g. in television sets or digital still and video camera's or many computer or audio/video applications or printers is executed preferably in the non-linear signal domain after a non-linear conversion of an original image signal in the camera. Such non-linear conversion usually is performed by applying a non-linear transfer-function to the signal which will be simply referred to as “gamma” or sometimes “degamma” in case of an inverse non-linear transfer function. In combination with the non-linear gamma of the display means 11 as shown in FIG. 1 preferably an increase of the color saturation above unity will cause hue errors, predominantly at the borders of the color gamut. The invention provides several methods for correction of those hue errors.

The location of the color saturation control CSC 5 of the display apparatus 3 is according to FIG. 1. Therein a basic diagram of a television system consisting of three main parts 1, 2 and 3 is shown. On the top a camera 1 and a transfer medium (TM) 2 is shown and at the bottom a display apparatus 3 in form of a television display with a CRT (cathode ray tube) or another kind of display means (like a Plasma Display Panel PDP or a Liquid Crystal Display LCD) is shown.

Usually a scene is registered by the camera 1 via a lens and a single light sensitive area image sensor, having a RGB (Red-Green-Blue) or another kind of color array. Next the RGB signals are offered to a 3×3 camera matrix for fitting the color gamut of the camera to a desired television standard like the EBU-standard (European Broadcasting Unit) or HDTV-standard (High Definition Television).

After the matrix the camera gamma is applied. It is intended for compensating the non-linear transfer of the display means 11 (e.g. CRT) at the end of the display apparatus 3.

Finally in the camera 1 the R′G′B′ signals are converted to the Luma signal Y′ and the color difference signals R′−Y′ and B′−Y′, which from the input signal to the display apparatus 3. As an alternative to the camera 1 the input signal (Y′, R′−Y′, B′−Y′) may be provided also by any other suitable way.

After the conversion the black level can be adjusted by adding a DC-level to the Luma signal Y′. The saturation can be adjusted by multiplying the color difference signal with a proper factor, which is indicated by “sat” in the figures.

Before the transfer medium 2 a coder can be applied and thereafter a decoder. The type of coder and decoder will depend on the type of the transfer medium 2.

The display 3 at first provides a black level control on the Luma signal Y′ and a saturation control CSC 5 on the color difference signals R′−Y′ and B′−Y′. At next the signals are converted back to R′, G′, B′ signals again by a transformation 7.

If the color gamut of the display 3 does not correspond with the gamut of the camera 1 (EBU or HDTV) a 3×3 display matrix 9 can be applied in order to minimize color reproduction errors.

Finally there is the display means 11 which shows the scene 13 registered by the camera 1 via its gamma transfer characteristic. It will be understood that a proper choice of the gamma is left up to a particular application. Here, in this context, a CRT gamma of 2.3 is used. Besides a CRT there are other display means 11 possible to be applied like a LCD (Liquid Crystal Display) and a PDP (Plasma Display Panel).

In general with regard to printers it may be relevant, that most printers have adopted the sRGB standard and therefore a gamma with slightly lower exponent than usual, e.g. a gamma with less gain near black than with a truly exponential curve is applied for pictures, e.g. a linear color bar, before printed. For a proper display on a PC monitor also a gamma with a slightly lower exponent than usual may be preferable. Otherwise usually printed figures would be too dark when printed or viewed on a monitor.

2. Maintenance of the Hue After the Display as Function of the Color Saturation Control

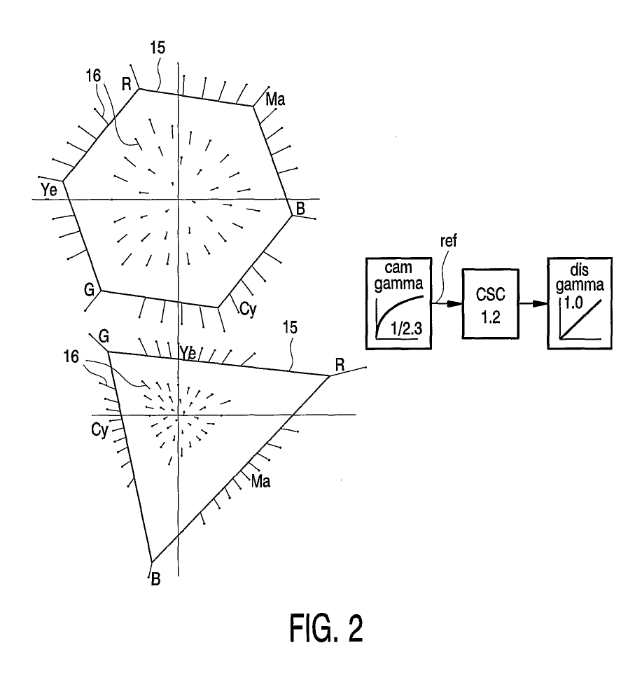

The first aspect of importance to realize is that after the camera gamma in general the hue is maintained as a function of the color saturation. From FIG. 2 it can be seen that the color saturation lines 16, also at the borders 15, have the same hue as a line drawn through white and a respective reference point. The location of the signals and its references are indicated by the icon in FIG. 2.

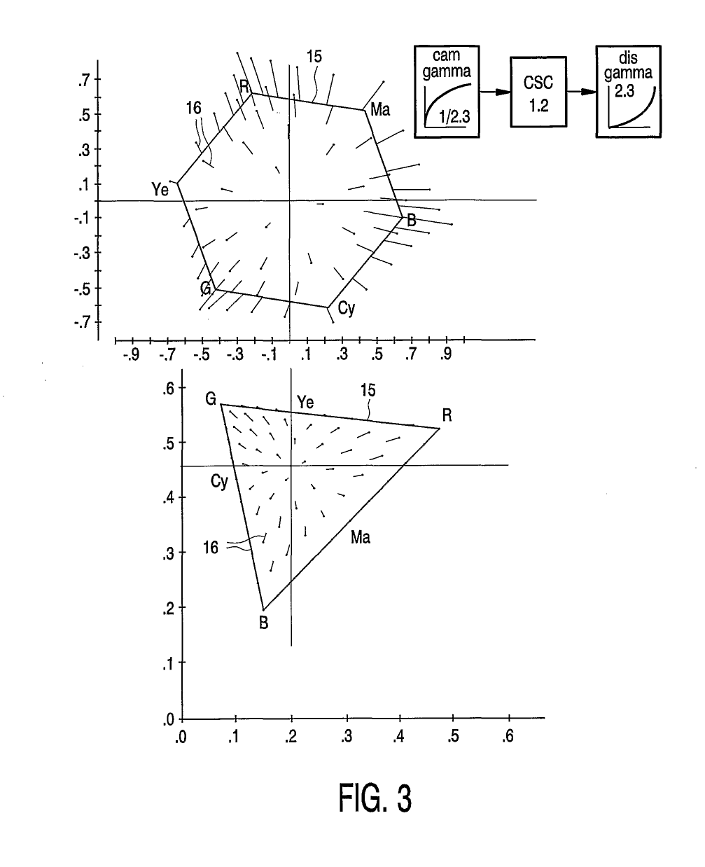

The second aspect is that after the non-linear display gamma and an increasing color saturation control 5 the hue of the colors in between the primary and the complementary colors is shifting towards the RGB primaries as shown in FIG. 3. A hue error may denote any kind of unnatural shifted color or abnormal tones upon changing a saturation control. Three methods are explained that are able to undo the hue errors caused by an increasing color saturation control 5.

In FIG. 3 the location of the signals and its references are indicated by the icon in FIG. 3. As a conduction as soon as an inside color supersedes the color gamut due to an increasing color saturation control, the hue error will start increasing as well. Hence it appears that the largest hue errors will happen at the border 15 of the color gamut.

Also in case of a color saturation control with a saturation value “sat” larger the unity after the camera gamma negative primary color contributions can occur. Besides the limitations of the transfer medium 2 the real bottleneck in handling negative primary signal contributions is of course the gamma of the display, which limits them to zero.

A hue analysis of the border colors with zero limited negative signals by the display gamma and a color saturation control of 1.5 has been compared to the very same but then with a display gamma able to process negative primary signal contributions. The results are not shown here but a first conclusion after comparing the color reproductions is that the hue errors are much less in case of a negative signal throughput of the display.

Despite the fact that it is not possible to reproduce negative primary light contributions, it is possible to regard their resulting color reproduction by making the display gamma sign sensitive. This means that a negative primary color before the display gamma is inverted to a positive signal and labeled by a negative sign signal. After the display gamma the sign determines whether the output of the display has to be inverted again or not. For a negative sign signal the display output will be inverted. A positive primary signal is labeled with a positive sign signal and is left unchanged.

As can be seen in FIG. 3 another conclusion from the analysis of the inner colors of a color gamut is that the hue of the colors in between the primary and the complementary colors are shifting towards the RGB primaries.

A third conclusion of FIG. 3 is that the largest hue errors happen near the yellow color and the smallest ones near blue, exactly opposite to the Federal Communications Commission (FCC) transmission luminance weights.

A detailed analysis of processing theoretically negative primary contributions by the display, which is not shown here, makes clear that the main cause of relative large hue errors at an increasing color saturation is the display gamma because it limits negative primary color contributions to zero.

### 2.1 First Embodiment of Hue Maintenance at the Output of the Display as a Function of the Saturation Control

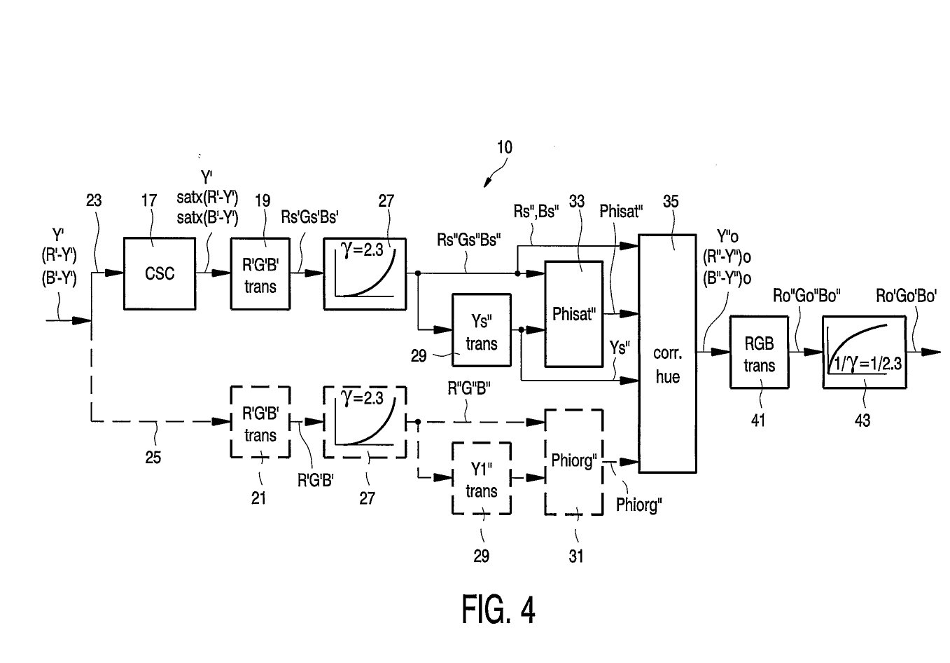

FIG. 4 is a flow-chart of a first preferred embodiment of the signal processing method, wherein the hue of the display after the saturation control is maintained. This means that the hue errors even at an increasing color saturation control CSC 17 are corrected. A first kind of hue restoration 10 functions as follows. The non-linear input signals, the Luma signal Y′ and the color difference signals (R′−Y′) and (B′−Y′), are offered to the color saturation control 17 and become respectively saturation-controlled image signals Y′ and {satx(R′−Y′)} and {satx (B′−Y′)}. The Luma and color difference signals as well with and without a modified saturation control are converted to primary color signals by transformations 19 and 21 respectively, i.e. the R′G′B′ signals of the camera and the Rs′Gs′Bs′ signals with a modified saturation control. The “s” in the Rs′Gs′Bs′ signals is used to indicate a modified saturation control. A first image signal is processed in form of the color saturation-controlled image signals Y′ and {satx(R′−Y′)} and {satx(B′−Y′)} and Rs′, Gs′, Bs′ in a first processing stream 23. A second image signal is processed in form of the original image signals Y′, R′−Y′, R′−Y′ and R′, G′, B′ in a second processing stream 25, which is indicated by a dashed line. The main signal path is indicated by a full line. However, the hue of the signals Y′, (R′−Y′), (R′−Y′) or R′G′B′ of the second processing stream 25 in comparison with the Y′, {satx(R′−Y′)}, {satx (R′−Y′)} or Rs′Gs′Bs′ signals of the first processing stream 23, i.e. the signals before the non-linear transfer function 27, have the very same hue.

The R′G′B′ signals read:
R′=(R′−Y′)+Y′
G′=(G′−Y′)+Y′, where (G′−Y′)=−(YR/YG)×(R′−Y′)−(YB/YG)*(B′−Y′)
B′=(B′−Y′)+Y′ (1)

The Y_{R}, Y_{G} and Y_{B} luminance contributions for obtaining the (G′−Y′) signal are according to the FCC standard (Y_{R}:Y_{G}:Y_{B}=0.299:0.587:0.114).

The Rs′Gs′Bs′ signals read:
Rs′=satx(R′−Y′)+Y′
Gs′=satx(G′−Y′)+Y′
Bs′=satx(B′−Y′)+Y′, (2)

The (G′−Y′) signal of the previously obtained G′ signal can be used.

Both signals of the processing streams 23 and 25—the R′G′B′ signal of the first processing stream 23 and the Rs′Gs′Bs′ signal of the second processing stream 25—are offered to two LUTs 27, which contain the CRT transfer function. Thereby a non-linear conversion of the R′G′B′−image signal into a predicted RGB-image signal R″, G″, B″ is performed in the second processing stream 25 and a non-linear conversion of the Rs′Gs′Bs′-image signal into a predicted saturation-controlled RGB-image signal Rs″, Gs″, Bs″ is performed in the first processing stream 23. This results in the predicted R″G″B″ signals representing the CRT output without modified saturation control and the predicted Rs″Gs″Bs″ signals including the modified saturation control. In formulas this reads:
R″=R″^{γ}, G″=G′^{γ}, B″=B′^{γ} and
Rs″=Rs′^{γ}, Gs″=Gs′^{γ}, Bs″=Bs′^{γ} (3)

In case a display type has been used with a transfer characteristic different from the one of a standard CRT with γ=2.3, for example a transfer characteristic of an LCD or PDP, then it is still preferred to apply the CRT transfer curve because every type of display should be in conformity with the CRT transfer characteristic.

For the conversion of the predicted R″G″B″ and the predicted Rs″Gs″Bs″ signals to respectively the seocnd Y1″ and first Ys″ luminance signals the luminance con-tributions of the concerned display are provided by re-transformations 29. Otherwise the maintenance of the luminance output of the display as described would be not correct. The processed second image signal Y1″ represents the original luminance output of the display for a saturation control of 1.0, while the saturation-controlled first image signal Ys″ concerns the luminance output of the display with a modified saturation control, which may be an increase or a decrease.

The conversion to the Luminance″ signals Y1″ and Ys″ by a re-transformation reads in formulas:
Y1″=Y_{Rdisplay}×R″+Y_{Gdisplay}×G″+Y_{Bdisplay}×B″
Ys″=Y_{Rdisplay}×Rs″+Y_{Gdisplay}×Gs″+Y_{Bdisplay}×Bs″, (4)
where Y_{Rdisplay}, Y_{Gdisplay} and Y_{Bdisplay} represent the luminance contributions of the display.

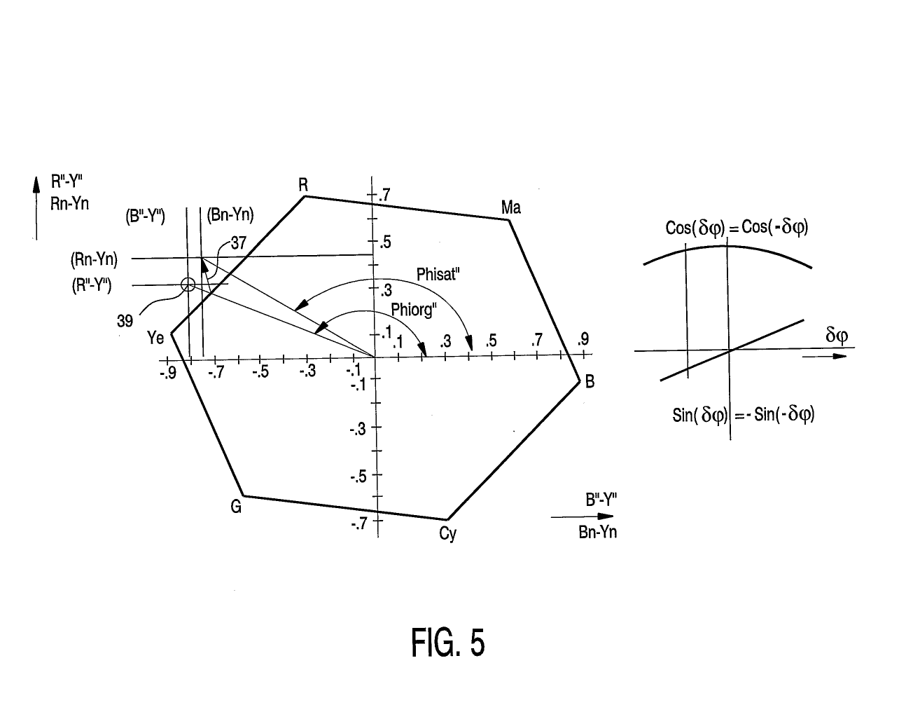

In unit 31 with the aid of the R″G″B″ and Y1″ signals a second hue angle Phiorg in the Chrominance″ plane is calculated and in unit 33 with the aid of the Rs″Gs″Bs″ and Ys″ signals a first hue angle Phisat. Both, Phiorg and Phisat, are predictions of the hue angle at the output of the display. Phiorg is the angle of a line through white in the center and the reproduced color by the display at a saturation control of 1.0. Phisat is the angle of a line through white in the center and the reproduced color by the display at an arbitrary saturation control larger than 1.0. This is elucidated in FIG. 5.

In units 31 and 33 with the aid of the function PhiHue (5) shown below the hue angles Phiorg″ and Phisat″ are calculated in the Chrominance″ plane with color difference signals using unity color reduction factors.

By writing Phiorg″=PhiHue(R″,B″, Y′) the second hue angle Phiorg″ will be calculated, while by Phisat″=PhiHue(Rs″,Bs″,Ys′) the first hue angle Phisat″ is returned.

Function PhiHue(Rh,Bh,Yh)

$$\{ PhiHue calculation with unreduced color difference signals \} \\ if ( Bh - Yh ) = 0 then \{ prevent division by zero \} \\ PhiHue = byte ( ( Rh - Yh ) < 0 ) x 1.5 xpi + byte ( ( Rh - Yh ) > 0 ) x 0.5 xpi \{ PhiHue = arctg ( v / u ) [ radians ] \} \\ else \{ taking into account the quadrants \} \\ PhiHue = arctan ( ( Rh - Yh ) / ( Bh - Yh ) ) + byte ( Bh - Yh ) < 0 ) xpi + byte ( ( Rh - Yh ) < 0 ) x byte ( ( Bh - Yh ) > 0 ) x 2 xpi ; \\ end \{ of function PhiHue \} \qquad ( 5 )$$

The proper quadrants are determined with the arc tan (arcus tangens) function.
If (Bh−Yh)=0 and (Rh−Yh)<0 then PhiHue will be 270 degrees or 1.5 ×pi when expressed in radians. If however (Bh−Yh)=0 and (Rh−Yh)>0 then PhiHue will be 90 degrees or 0.5 ×pi in radians. For all other conditions then (Bh−Yh)=0 the angle PhiHue is calculated by arc tan((Rh−Yh)/(Bh−Yh)) inclusive taking into account the quadrant. This is because
for 0≦x<∞ it counts that 0≦arctg(x)<pi/2 has to be in the I and III quadrant
for −∞<x≦0 it counts that −pi/2<arctg(x)≦0 has to be in the II and IV quadrant
where x represents (Rh−Yh)/(Bh−Yh).

Only for quadrant I, the angle is correct, for the other ones some conditions have been added. For (Bh−Yh)<0 it counts that PhiHue should be in quadrant II or III. By adding 180 degrees (pi) the negative angle is located in quadrant II and the positive angle in quadrant III. For (Rh−Yh)<0 and (Bh−Yh)>0 a negative angle is found. By adding 360 degrees (pi) this angle is located in quadrant IV.

With the angles Phiorg″ and Phisat″ available the hue correction of the display output can be performed by obtaining a corrected hue value 39 in unit 35 according to procedure (6).

Procedure HueRestoration(Rn,Bn,Yn,φn,φr)

{Rn,Bn and Yn are related to φn, the signals and angle to be corrected]

(φr is the reference angle to correct to)
(B″−Y″)=(Bn−Yn)×cos(φn−φr)+(Rn−Yn)×sin(φn−φr)
(R′−Y″)=(Rn−Yn)×cos(φn−φr)−(Bn−Yn)×sin(φn−φr)
(G″−Y′)=−(Y_{Rdisplay}/Y_{Gdisplay})×(R′−Y′)−(Y_{Bdisplay}/Y_{Gdiplay})*(B′−Y′)
{(B″−Y″), (R″−Y′) and (G″−Y′) are the unreduced color difference signals of the display after hue correction}
Ro″=(R″−Y″)+Yn
Go″=(G″−Y″)+Yn
Bo″=(B″−Y′)+Yn{Ro″Go″Bo″ are the output signals of the display} end (of procedure HueRestoration} (6)
By executing the procedure HueRestoration(Rs″,Bs″, Ys″,Phisat″,Phiorg″) the hue corrected Ro″Go″Bo″ values of the output of the display are obtained. Here Rs″, Bs″ and Ys″ are related to Phisat″ after the gamma of the display.

FIG. 5 shows a schematic diagram to illustrate the hue restoration with unreduced color difference signals in the 2D Chrominance plane. An example of the hue restoration of a yellowish color is indicated by reference mark 39.

The color reproduction of the yellowish color at an increasing color saturation is shown by arrow 37. Its (Bn−Yn) signal is negative while its (Rn−Yn) signal is positive. The cos(inus) and sin(us) values as a function of deltaPhi, represented by δφ=Phisat″-Phiorg″, are drawn on the right hand side of FIG. 5. For the yellowish color δφ is negative. From the (B″−Y″) signal according procedure (6) the negative (Bn−Yn) part will become somewhat less negative after the multiplication with cos(δφ) and more negative again by adding (Rn−Yn)×sin(δφ) which is negative (+x−=−). The positive (R″−Y″) signal becomes somewhat smaller due to (Rn−Yn)×cos(δφ) and decreases further the subtraction of the (Bn−Yn)×sin(δφ) of which both (Rn−Yn) and sin(δφ) are negative (−(−x−)=−). Finally the hue corrected yellowish color is located within the small circle 39.

As shown in FIG. 4 a display signal is obtained by:

transforming the output signals Yo″, (R″−Y″)o, (B″−Y″)o into output RGB-image signals Ro″,Go″,Bo″ in unit 41; and

non-linear converting the output RGB-image signals Ro″,Go″,Bo″ into display signals Ro′,Go′,Bo′ in unit 43.

By undoing the previously CRT gamma on the Ro″Go″Bo″ signals by means of the degamma in unit 43 the Ro′Go′Bo′ signals are achieved which can be used as input signals for the display.

The degamma reads:
Ro′=Ro″^{1/γ}, Go′=Go″^{1/γ}, Bo′=Bo″^{1/γ} (7)
After the display, being a CRT, LCD, PDP or whatever other type with the transfer characteristic of the CRT as the standard, the hue errors will be corrected and the modified saturation is still maintained.

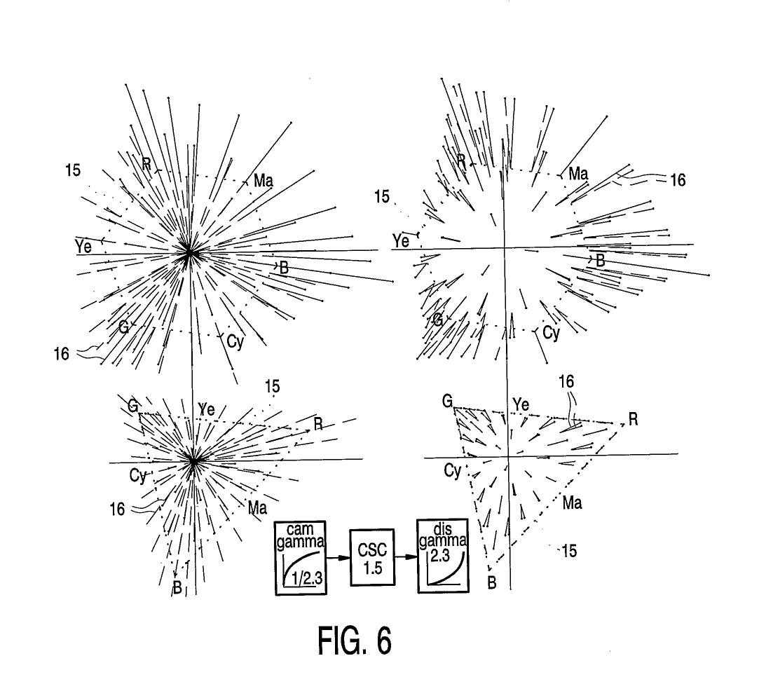

On the left hand side of FIG. 6 the corrected hue errors are shown in the 2D UCS1976 and Chrominance″ planes for a camera gamma of 1/2.3, a CRT gamma of 2.3 and a color saturation control of 1.5. The kind of signals used is indicated by the icon. The thin dashed lines show the ideal hue by means of a line through white at the center and the starting reference point for which the saturation control is 1.0. The fat full lines are representative for the color reproduction from the starting reference point to the final color reproduction of the display. A comparison of the differences of the angles of the thin dashed lines and fat full lines offer a measure for the quality of the hue correction.

At the right hand side of FIG. 6 the thin dashed lines show the color reproduction of the display output without hue correction while the fat full lines show the color reproduction inclusive the hue correction of the diagram in FIG. 4. The differences between the thin dashed and fat full lines show the amount of hue correction.

### 2.2 Second Embodiment of Hue Correction

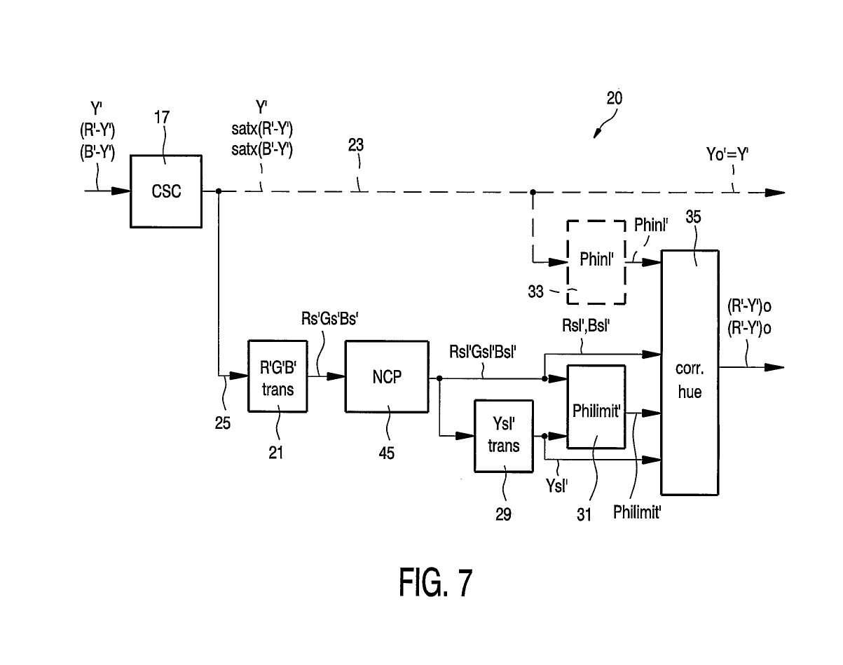

FIG. 7 is a flow-chart of a second preferred embodiment of the signal processing method, wherein the hue of the display after the saturation control is maintained without a CRT gamma and a degamma transfer. A second embodiment of hue correction is shown without CRT gamma predictions neither undoing that CRT gamma. This method is based on the knowledge that large hue errors only will happen if negative primary color contributions appear at an increasing color saturation control.

Units of FIG. 7 performing basically the same functions as compared to FIG. 4 have been labeled with the same reference marks as used in FIG. 4. Again the main signal path is indicated by a full line. A second kind of hue restoration 20 functions as follows. The unit 45 (Negative Color Prevention—NCP) prevents negative colors by limiting negative Rs′Gs′Bs′ signal contributions to zero. In formulas this reads:
if Rs′<0 then Rsl′=0 else Rsl′=Rs′
if Gs′<0 then Gsl′=0 else Gsl′=Rs′
if Bs′<0 then Bsl′=0 else Bsl′=Bs′ (8)

It is interesting to realize that this prevention of negative color contributions can also be regarded or, if preferred, replaced by a simulated CRT gamma immediately followed by a CRT degamma. This combination has a linear overall transfer and does nothing else then limiting negative color contributions to zero.

Next a second hue angle Philimit′ is calculated in a unit 31 by means of function (5) written as: Philimit′=PhiHue(Rsl′ Bsl′ Ysl′), while a first hue angle Phinl′, which is not limited (“nl″) as compared to the second hue angle Philimit′, is determined by Phinl′=PhiHue(satx(R′−′)+Y'satx(R′−Y′)+Y′,Y′).

In unit 35 the hue correction can be executed with the aid of procedure (6) by substituting

HueRestoration(Rsl′,Bsl′ Ysl′,Philitnit′,Phinl′),

where Phinl′ acts as the reference hue φr and Philimit′ as the hue φn to be corrected by using the Rsl′, Bsl′ and Ysl′ signals.

The second preferred embodiment of the signal processing method of hue correction has to be distinguished from the first preferred embodiment of the signal processing method of hue correction as described with FIG. 4 in section 2.1. The first embodiment of FIG. 4 executes the hue restoration in the color space after the simulated CRT display by means of units 27. Then, by the means of the CRT degamma in unit 43, the Ro′Go′Bo′ signals before the display are obtained. The second embodiment of FIG. 7 however applies the hue restoration in the color space before the display, i.e. in the non-linear space between the camera gamma and the display panel. That is also the reason why Y′ and other signals are denoted with a dash.

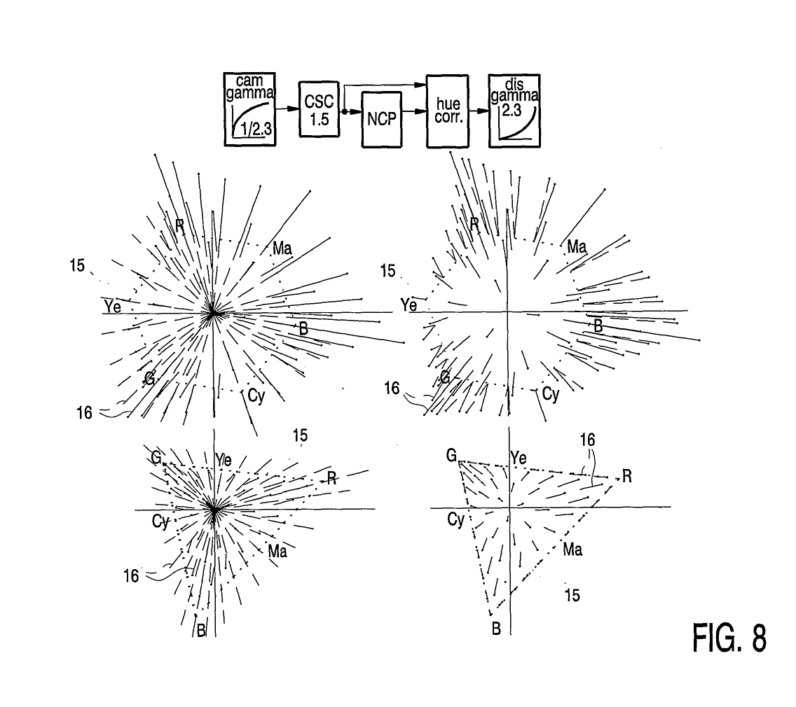

The consequence of this second embodiment of hue restoration method is that only in case of negative color contributions a hue correction will be performed. The result is shown in FIG. 8. Again the icon indicates the kind of signals. On the left hand side the quality of the second embodiment can be judged in the Chrominance″ and UCS1976 color planes of the display output by comparing the thin dashed reference lines with the fat full lines of the border colors. On the right hand side of FIG. 8 is shown how much the hue errors are corrected by showing the thin dashed lines without and the fat full lines with hue restoration.

No hue changes are performed according to the second embodiment of hue restoration method for colors inside of the UCS 1976 color gamut after the increase of the color saturation control. This can be seen in the lower part of FIG. 8.

### 2.3 Third Embodiment of Hue Correction in Particular as Alternative of the Second Embodiment

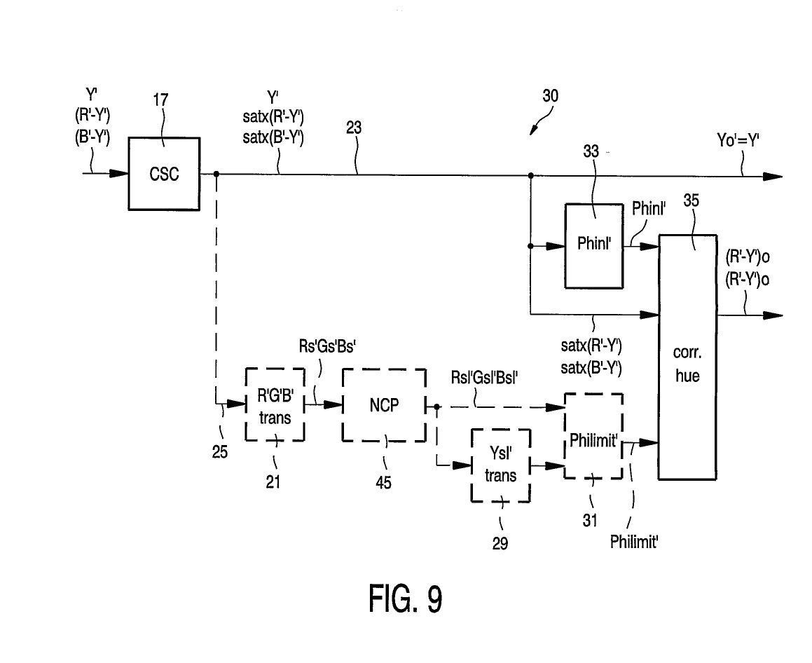

The third embodiment of hue correction is a particular preferred alternative of the second embodiment of the previous section. A third kind of hue restoration 30 functions as follows. In contradistinction to the second embodiment now the color difference signals satx(B′−Y′) and satx(R′−Y′) instead of the Rsl′,Bsl′ and Ysl′ signals of the flow-chart of FIG. 7 are used. The flow-chart of the third embodiment of hue restoration method is shown in FIG. 9. By the third preferred embodiment of the signal processing method, the hue of the display is maintained with a minimum of processing in the signal path by using the color difference signals satx(R′−Y′), satx(B′−Y′) after the color saturation control.

Units performing basically the same functions as compared to FIG. 4 or FIG. 7 have been labeled with the same reference marks as used in FIG. 4 and FIG. 7. The unit 45 (NCP) in FIG. 7 and FIG. 9 prevents negative colors by limiting negative Rs′Gs′Bs′ signal contributions to zero. The main signal path is indicated by a full line. The second processing stream 25 is indicated by a dashed line.

In general it is necessary that for the hue correction in unit 35 the signals related with Philimit′ angle are applied as shown in FIG. 7. With an empirical found adaptation as a function of the color saturation control it is however possible to apply the color difference signals satx(R′−Y′) and satx(B′−Y′) after the color saturation control and nevertheless to approximate rather well the same hue correction of the second method. The latter is shown in FIG. 9. The advantage of the third embodiment of hue restoration method is that the extra amount of processing in the signal path is limited to the hue correction of unit 35 only.

The empirical adaptation of the hue correction δφ s f(sat) is as follows:
δφ=(0.7−0.4*(sat−1.5))×(Philimit′−Phinl′) (9)
The hue correction in unit 35 reads:
(B′−Y′)o=sat×(B′−Y′)×cos(δφ)+(R′−Y′)×sin(δφ), and
(R′−Y′)o=sat×(R′−Y′)×cos(δφ)−(B′−Y′)×sin(δφ), (10)
Equation (10) is conform with the two upper equations of procedure (6) when replacing (Bn−Yn) and (Rn−Yn) by respectively satx(B′−Y′) and satx(R′−Y′), and (φn−φr) by (δφ).

The differences between the second and third embodiment of hue correction method have been analyzed in a Chrominance″ plane at a color saturation control of 2.0. The results, which are not shown here, demonstrate only few differences, however the second embodiment has a somewhat better hue correction than the third one. When decreasing the color saturation control towards 1.0 the differences between both embodiments become smaller and finally negligible. The conclusion is justified that both embodiments of hue correction method effectively limit negative color contributions as a function of the color saturation control to zero. The third embodiment of FIG. 9 is a good alternative for the second method of FIG. 7.

### 2.4 Evaluating the First and Second Hue Correction Embodiment

A comparison has also been made between the first embodiment of hue correction method of FIG. 4 and the second one of FIG. 7. The differences between them are not depicted here but have been analyzed in the Chrominance″ and UCS1976 planes at a color saturation control of 1.5. At a first glance the impression is that the first embodiment of hue correction, performs a bit better than the second one. A more accurate comparison makes however clear that the first hue correction embodiment restores the hue of the reference points of which the starting points are the closest ones near the borders of the Chrominance″plane and the UCS1976 color gamut. At those locations the second hue correction embodiment fails because there are no negative color contributions. Therefore the main difference between the first and second hue correction embodiment is that the first one is able to restore the hue of colors with as well as without negative color contributions after an increasing color saturation control after the camera gamma. The second embodiment can only restore the hue when negative color contributions take place.

Another difference between the first and second hue correction embodiment concerns the color reproduction on the borders, especially on the G-R line where the human eye is most sensitive for color deviations. In the UCS1976 plane the border colors of the second hue correction embodiment stay more near yellow then of the first embodiment which tends slightly towards primary green and red. When maintaining the yellow color reproduction is the goal of hue correction this looks like an advantage of the second hue correction embodiment.

However, there is another phenomena related to this effect. In the UCS1976 plane two accidental starting reference points can be chosen between yellow and red which almost lie on a straight line. For the first hue correction embodiment the final color reproduction of those two reference points are very close to each other. For the second hue correction embodiment however there is a large difference meaning that the hue angle will shift back towards yellow when the input color approaches the border of the color gamut.

In particular an orange test picture can demonstrate, that the color saturation increases linearly from zero to fully saturated orange. The color analysis of such kind of orange picture for a color saturation control of 1.8 shows in an accurate view that the closer the input colors approach the border of the color gamut, resulting in negative color contributions after the saturation control, the more the display output color is shifting towards the red primary. The very same shift direction, although smaller, counts for the first hue correction embodiment. In the second hue correction embodiment, as soon as negative primary color contributions take place the colors start shifting in the opposite direction, i.e. towards yellow.

The differences between the second hue correction embodiment on the bottom-left and the straight forward processed saturation control only happen when a negative color contribution takes place. Therefore the first conclusion is that when an input color starts approaching the border of the color gamut, the first hue correction embodiment offers a more natural flow with maintenance of the shift towards the red primary while the second hue correction embodiment starts shifting in the opposite direction towards yellow. This does however not mean that from a perception point of view the second hue correction embodiment reproduces an unacceptable flow. A second, already mentioned, conclusion is that hue correction of colors inside a color gamut without negative primary color contributions, as offered by the first hue correction embodiment, has much advantage because it restores the hue of those colors as well.

### 2.5 Membership Functions for the Hue Correction

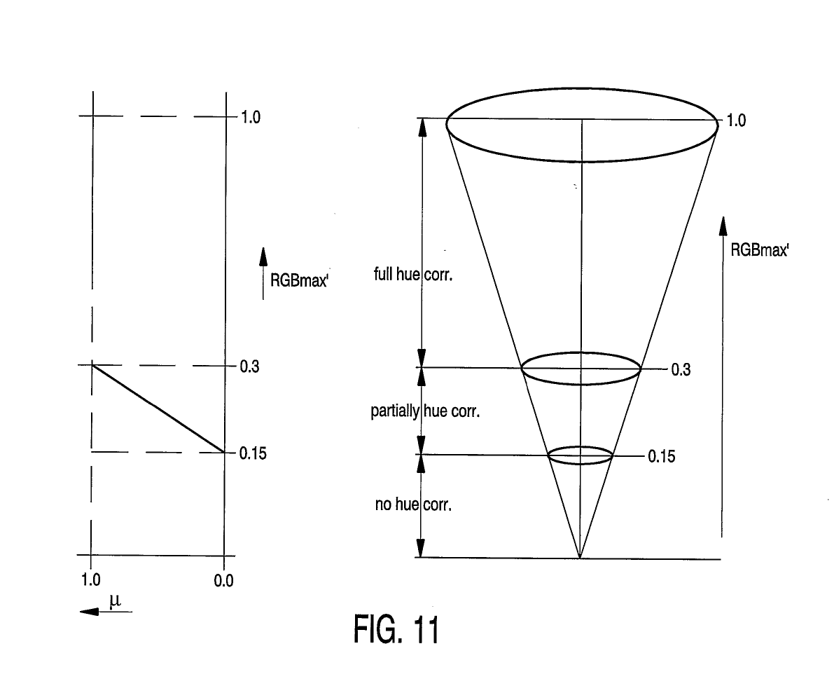

The visibility of the hue correction usually starts at a certain RGBmax″ level at the output of the display. By examining an orange test picture at a user saturation control of 2.0 it has become clear that the hue correction should be active above an RGBmax″ level of 0.06 at the CRT output in case of a CRT gamma exponent of 2.3 and a camera gamma with the inverse exponent of 1/2.3. This means that it is possible to introduce a membership function for the hue control. In principle the effect of a membership function is demonstrated in FIG. 11 for elucidation.

When taking into account the CRT gamma value, the RGBmax′ level after the camera becomes 0.06^{1/2.3}=0.3. On the left hand side of FIG. 11 a first membership function for hue correction after the camera gamma is shown only as an example for elucidation purposes. The starting value of RGBmax′ of 0.15 is rather arbitrary and corresponds with a RGBmax″ value of 0.013 at the output of the display. In case of a camera gamma with an exponent larger than 1/2.3 (i.e. 1/2.3<γc<1) this membership guarantees a lowest visible RGBmax″ level of 0.06 at the output of the display because then the lowest RGBmax″ level will be smaller than 0.06. For a larger camera gamma the picture at the output of the display will be darker, so hue errors will become less visible.

For the output μ of the first membership function for hue correction reads as follows:
μ=0 for RGBmax′<=0.15
μ=(RGBmax′−0.15)/(0.3−0.15) for 0.15<RGBmax′<=0.3
μ=1 for RGBmax′>0.3 (11)
Such kind of membership function can be realized mathematically or with a lookup table (LUT) and offers the possibility to switch off and/or bypass the hue measurement and correction for RGBmax′<=0.15. For RGBmax′ values above 0.15 the hue correction in procedure (6) is adapted as follows:
(B″−Y″)=(Bn−Yn)×cos(μ×(φn−φr))+(Rn−Yn)×sin(μ×(φn−φr)), and
(R″−Y″)=(Rn−Yn)×cos(μ×(φn−φr))−(Bn−Yn)×sin(μ×(φn−φr)) (12)
Depending on the output μ of the membership function the hue will be fully corrected for RGBmax′ values above 0.3 and proportionally for 0.15<RGBmax′<=0.3.
Equation (10) of the third hue correction method including the first membership function reads as follows:
(B′−Y′)o=satx(B′−Y′)×cos(μ×δφ)+(R′−Y′)×sin(μ×δφ), and (13)
(R′−Y′)o=satx(R′−Y′)×cos(μ×δφ)−(B′−Y′)×sin(μ×δφ),

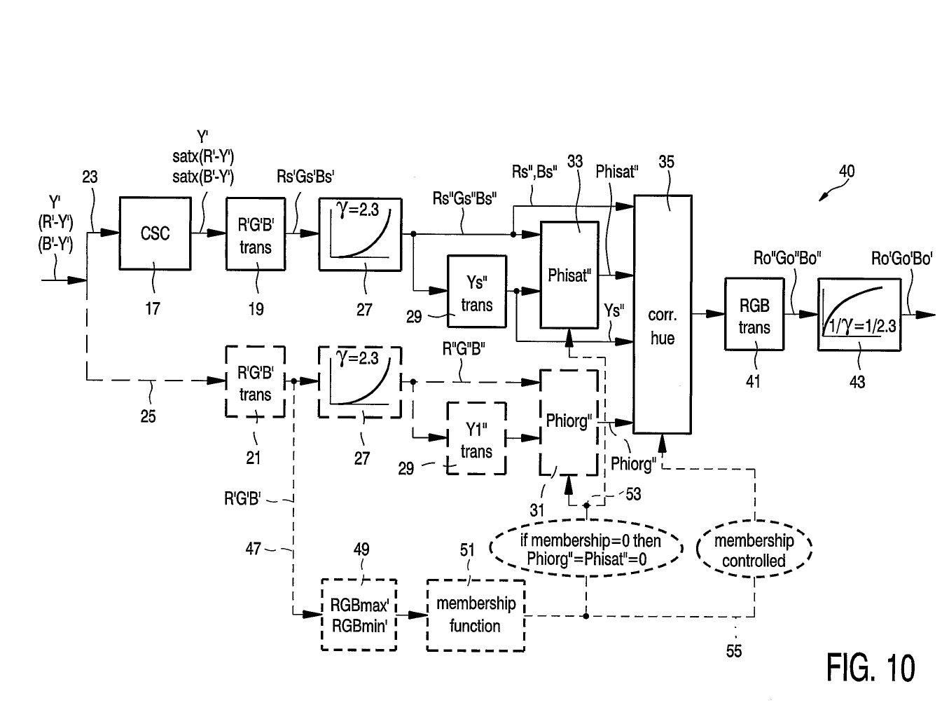

In FIG. 10 an example of the application of an arbitrary membership function is shown in a modified flow-chart of the original block diagram of FIG. 4. For reasons of clarity the processing stream of the membership function is shown by a dotted line. In principle also the flow-charts of FIGS. 7 and 9 can be used added by a membership function processing stream instead the one of the flow-chart of FIG. 4. A further kind of hue restoration 40 functions as follows. To illustrate the functional connection of a membership function in FIG. 10 a membership processing stream 47 is branched off from the second processing stream 25. The membership processing stream 47 comprises the steps of:

detecting an RGB extremum in unit 49

obtaining a membership function output in unit 51

As a result in a first membership processing branch 53, which is connected to units 31 and 33 the values of a first hue angle Phisat″ and second hue angle Phiorg″ are effected. Furthermore in a second membership processing branch 55, which is connected to unit 35 the hue correction in unit 35 is membership controlled.

Supposed that the RGBmax′ membership function of equation (11) has been applied. In that case the RGBmax′ membership function decides that for RGBmax′<=0.5 the Phisat″ and Phiorg″ calculations are switched off and their outputs are replaced by an angle of 0 degrees. The hue correction is controlled by the RGBmax′ membership function of equations (11) and (12) or (13).

The result is shown on the right hand side of FIG. 11 in the 3D Chroma space of with RGBmax′ as the vertical dimension. The RGBmax′ membership function offers a full, partially and no hue correction.

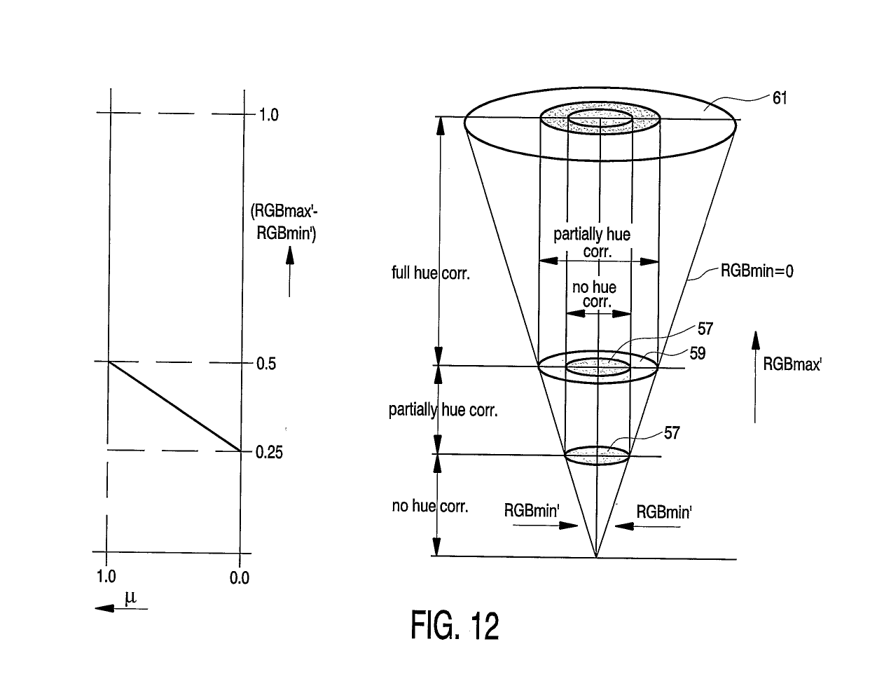

The membership function in the flow-chart of FIG. 10 is intended for general use. In a specifically preferred embodiment shown like the one of FIG. 12 the membership function is applied for preventing dividing problems with the PhiHue calculations of function (5) for small color difference signals. It is to be noticed that even at an RGBmax′ level of 1.0 Volt the color difference signals can be very small. It does not only happen in the lower regions of the 3D Chroma space. By replacing the previous RGBmax′ membership function of FIG. 11 by an (RGBmax′-RGBmin′) one, the divider problems can be solved. The (RGBmax′-RGBmin′) membership function determines whether the hue will be calculated or not. If yes, then the hue again will be proportionally corrected according to that (RGBmax′-RGBmin′) membership function. For the RGBmax′ and RGBmin′ signal this reads:
RGBmax′=max{R′G′B′} and
RGBmin′=min{R′G′B′}, (14)
being respectively the largest and the smallest of the three R′G′B′ signals.

Additionally by examining an orange test picture of the above mentioned kind at a saturation control of 2.0 it has become clear that the hue correction should be active above an (RGBmax″-RGBmin″) threshold level of about 0.3 at the CRT output in case of a CRT gamma of 2.3 and a camera gamma with the inverse exponent of 1/2.3. For a camera gamma larger than 1/2.3 (i.e. 1/2.3<γ<1) the visibility of the hue correction will somewhat increase because the colors will move a little towards the borders of the color space. Although for a larger camera gamma the picture at the output of the display will be darker, the hue correction still can be clearly seen in the orange test picture. Therefore instead of 0.3 the minimum (RGBmax′-RGBmin′) level is preferably decreased to 0.2, resulting in a value of 0.21/2.3=0.5 before the CRT. This leads to the (RGBmax′-RGBmin′) second membership function depicted in FIG. 12, where the starting value has been chosen at 0.25 and which is safely preventing divider problems. This is in particular advantageous for practical hardware implementations of the embodiments described above.

The output η of this (RGBmax′-RGBmin′) membership function reads as follows:
η=0 for (RGBmax′-RGBmin′)<=0.25
η=((RGBmax′-RGBmin′)−0.25)/(0.5−0.25) for 0.25<(RGBmax′-RGBmin′)<=0.5
η=1 for (RGBmax′-RGBmin′)>0.5 (15)
This membership function can be realized mathematically or with a lookup table (LUT) and offers the possibility to switch off and/or bypass the hue measurement and correction for (RGBmax′-RGBmin′) smaller than or equal to 0.25 Volt. For (RGBmax′-RGBmin′) values above 0.25 Volt the hue correction in procedure (6) is adapted as follows:
(B″−Y″)=(Bn−Yn)×cos(η×(φn−φr))+(Rn−Yn)×sin(η×(φn−φr)), and
(R″−Y″)=(Rn−Yn)×cos(η×(φn−φr))−(Bn−Yn)×sin(η×(φn−φr)) (16)
Depending on the output s the hue will be fully corrected for (RGBmax′-RGBmin′) values above 0.5 Volt and proportionally for 0.25 Volt<(RGBmax′-RGBmin′)<=0.5 Volt.

On the right hand side of FIG. 12 the (RGBmax′-RGBmin′) membership function is shown in the 3D Chroma color space. The inner vertical lines indicate the 3D gray area 57 where no hue correction will happen, neither the divider function for calculating PhiHue will be executed. The combination of the outer and inner vertical lines indicate the shaded area 59 where a partially hue correction is performed being proportional to n in the middle part of the membership function. Outside the shaded area 59, i.e. in area 61, the full hue correction will be applied.

It is to be noticed for the (RGBmax′-RGBmin′) signals that for white or gray colors RGBmax′=RGBmin′ and that for the border colors of the Chroma space RGBmin′=0, i.e. in these areas a membership function is particularly advantageous.

It is also possible to apply the Rs′Gs′Bs′ signals after the saturation control for detecting the RGBmax′ and RGBmin′ signals for the (RGBmax′-RGBmin′) membership control. In that case the membership function becomes dependent on the color saturation control and requires the (RGBmax′-RGBmin′) input to be preferably at least 2.0 in stead of 1.0 in case of a large color saturation control. For the three primary and three complementary colors count that if the maximum signal is 1.0 Volt that at a saturation control of 2.0 the (RGBmax′-RGBmin′) signal will become 2.0 Volt. For example for B=1.0 and R=G=0 at a saturation control of 2.0 the (RGBmax′-RGBmin′) amplitude becomes 1.886−(−0.114)=2.0. This also counts for the red and green primaries as well as the yellow, cyan and magenta complementary colors.

It is to be noticed that it is also possible to realize a membership function with the Chroma amplitude as an input signal. In that case for the unreduced color difference signals the relation holds:
Chroma=range ×\sqrt{(R′−Y′)²(B′−Y′)²}

Two square functions and a single root calculation are however much more difficult to realize than the previously described subtraction of (RGBmax′-RGBmin′). The only difference between both is that the Chroma signal will offer a circle area in the 3D Chroma color space where the (RGBmax′-RGBmin′) signal offers an hexagon proportional to the outer border of the color space. This detail can be regarded as a preferred advantage.

When applying the (R′−Y′) and (B′−Y′) color difference signals their membership function will result in a square area in the 3D Chroma color space what can be regarded also as a true disadvantage. Moreover the realization of that membership function is rather complex because their minimum as well as their maximum has to fulfill the membership conditions. These are as follows:

if min(abs(R′−Y′), abs(B′−Y′))<=0.25 and max(abs(R′−Y′), abs(B′−Y′))<=0.25 then η=0, so no hue correction will happen.

if min(abs(R′−Y′), abs(B′−Y′))>0.25 and max(abs(R′−Y′), abs(B′−Y′))>0.25 and min(abs(R′−Y′), abs(B′−Y′))<=0.5 and max(abs(R′−Y′), abs(B′−Y′))<=0.5 then η=(max(abs(R′−Y′), abs(B′−Y′))−min(abs(R′−Y′), abs(B′−Y′)))−0.25)/(0.5−0.25), resulting in the proportional hue correction from zero to full,

if min(abs(R′−Y′), abs(B′−Y′))>0.5 and max(abs(R′−Y′), abs(B′−Y′))>0.5 then η=1, offering a full hue correction.

To summarize, the saturation of colors in a displayed image may be increased by means of a saturation control CSC. A hue error may occur if for a given pixel or area of pixels, not only the color becomes more saturated but also the color of pixel changes.

The present invention proposes in a first variant to predict the resulting color after a saturation control 17 by applying an estimated gamma-function of a display device 11 in a first processing stream 23 to the saturated signal (Y′, satx(R′−Y′), satx(B′−Y)) thus obtaining a saturated color and in a second processing stream 25 to the original signal (Y′, R′−Y′, B′−Y), i.e. the signal without increased saturation, thus obtaining the original color. Subsequently, the saturated color is corrected in a unit 35 to the original color, while maintaining its increased saturation. In a second variant the need of predicting the hue of the output of the display is removed by offering a hue correction 35 after the color saturation control 17 when negative color contributions happen at that location before the display. In a third variant it is possible to apply a color difference signal after the color saturation control 17 and it is possible to approximate the hue correction 35 of the second variant within an empirical found adaptation as a function of the color saturation control 17. Various kinds of membership functions as shown in FIGS. 10, 11 and 12 can be advantageously applied to prevent divider problems upon processing in particular in hardware applications.

While the invention has been described in detail, the foregoing description is in all aspects illustrative and not restrictive. It is understood that numerous other modifications and variations can be devised without departing from the scope of the invention. The features disclosed in the foregoing description, in the claims and/or in the accompanying drawings may, both separately and in any combination thereof, be material for realizing further developed configurations of the invention in diverse forms thereof.

Accordingly, the present invention is intended to embrace all such alterations, modifications and variations that fall within the spirit and scope of the appended claims. In particular any reference signs in the claims shall not be construed as limiting the scope of the invention. The wording “comprising” does not exclude other elements or steps. The wording “a” or “an” does not exclude a plurality.

### REFERENCE NUMERALS

1 camera
2 transfer medium
3 display apparatus
5 color saturation control (CSC)
7 transformation
9 display matrix
10 hue restoration
11 display means, CRT, LCD, PDP
13 scene borders of the gamut
16 color saturation lines
17 color saturation control
19 R′G′B′−transformation
20 hue restoration
21 R′G′B′−transformation
23 first processing stream
25 second processing stream
27 non-linear converting-unit
29 re-transformations/re-transforming
30 hue restoration
31, 33 unit for determining hue angle
35 unit for obtaining a corrected hue value
37 arrow indicating color reproduction
39 corrected hue value
40 hue restoration RGB-transformation
43 non-linear converting unit
45 negative color prevention (NCP)
47 membership processing stream
49 unit for detecting extremum
51 membership function
53 first membership processing branch
55 second membership processing branch
57 area of no hue correction
59 area of partial hue correction
61 area of full hue correction
B′, B″, Bs″, Bsl′ blue color component
degamma inverse display transfer-function
G′, G″, Gs″, Gsl′ green color component
gamma display transfer-function
Phisat″, Phinl′ first hue value
Phiorg″, Philimit′ second hue value
(R′, G′, B′) RGB-image signal
(R″, G″, B″) predicted RGB-image signal
(R′−Y′)o, (B′−Y′)o hue corrected (non-linear) color component
R′−Y′, B′−Y′/R″−Y″, B″−Y″ color difference signal/color component/coordinates
R′, R″, Rs″, Rsl′ red color component
(Ro′, Go′, Bo′) display signal
(Ro″, Go″, Bo″) output RGB-image signal
(Rs′, Gs′, Bs′)saturation-controlled RGB-image signal
(Rs″, Gs″, Bs″) predicted saturation-controlled RGB-image signal
(Rsl′, Gsl′, Bsl′) limited image signal
sat saturation value
satx(R′−Y′), satx(B′−Y′) non-linear chroma component
(Y′, R′−Y′, B′−Y′) input image signal
(Y′, satx(R′−Y′), satx(B′−Y)) saturation-controlled image signal
Y1″, Ys″/Y′, Ysl′ luminance component
(Y1″, R1″−Y1″, B1″−Y1″) processed second image signal
(Y′o, (R′−Y′)o, (B′−Y′)o)/(Y″o, (R″−Y″)o, (B″−Y″)o) output signal
Y″o hue corrected luminance component
Ys″ (linear) luminance component
(Ys″, Rs″−Ys″, Bs″−Ys″) saturation-controlled first image signal
(Ysl′, Rsl′−Ysl′, Bsl′−Ysl′) limited second image signal

1. An image signal processing method of controlling a color saturation for an image, the method comprising the steps of:
providing an input image signal (Y′, R′−Y′, B′−Y′);
applying a saturation control (17) to the input image signal resulting in a saturation-controlled image signal (Y′, satx(R′−Y′), satx(B′−Y′)); wherein
a hue restoration (10, 20, 30, 40) is applied on basis of the saturation-controlled image signal (Y′, satx(R′−Y′), satx(B′−Y′)) by:
determining a first hue value (Phisat″, Phinl′) from a first image signal in a first processing stream (23), and
determining a second hue value (Phiorg″, Philimit′) from a second image signal in a second processing stream (25);
obtaining a corrected hue value (39) from the first hue value (Phisat″, Phinl′) and/or the second hue value (Phiorg″, Philimit′);
obtaining an output signal (Y″o, (R″−Y″)o, (B″−Y″)o/Y′o, (R′−Y′)o, (B′−Y′)o) based on the corrected hue value (39).

2. The method as claimed in claim 1 characterized in that the input image signal (Y′, R′−Y′, B′−Y′) is formed by a luminance component (Y′) and a color component (R′−Y′, B′−Y′).

3. The method as claimed in claim 1 characterized by determining (FIG. 5) a first or second hue value as an angle in a 2D-plane of difference coordinates (R″−Y″, B″−Y″/R′−Y′, B′−Y′), wherein the difference coordinates are formed by a color component (R″, B″, Rs″, Bs″/R′, B′, Rsl′, Bsl′) and a luminance component (Y″, Ys″/Y′, Ysl′) of a first or second image signal.

4. The method as claimed in claim 1 characterized in that the corrected hue value is obtained by selecting the first hue value (Phisat″, Phinl′) as a reference and the second hue value (Phiorg″, Philimit′) as the corrected hue value.

5. The method as claimed in claim 1 characterized in that the output signal is obtained by using the corrected hue value in a trigonometric function.

6. The method as claimed in claim 1 characterized by maintaining a saturation value (sat) of the saturation-controlled image signal (Y′, satx(R′−Y′), satx(B′−Y′)) in the output signal (Y″o, (R″−Y″)o, (B″−Y″)o/Y′o, (R′−Y′)o, (B′−Y′)o).

7. The method as claimed in claim 1 characterized in that the hue restoration (10) is applied (FIG. 4) on basis of a predicted after-display transfer-function signal.

8. The method as claimed in claim 1 characterized in that
the first image signal is formed by the saturation-controlled image signal (Y′, satx(R′−Y′), satx(B′−Y′)), and
the second image signal is formed by the input image signal (Y′, R′−Y′, B′−Y′).

9. The method as claimed in claim 8 characterized in that the first processing stream (23) comprises the steps of:
transforming (19) the first image signal (Y′, satx(R′−Y′), satx(B′−Y′)) into a RGB-image signal (Rs′, Gs′, Bs′);
non-linear converting (27) the RGB-image signal (Rs′, Gs′, Bs′) into a predicted saturation-controlled RGB-image signal (Rs″, Gs″, Bs″)
re-transforming (29) the predicted saturation-controlled RGB-image signal (Rs″, Gs″, Bs″) into a saturation-controlled first image signal (Ys″, Rs″−Ys″, Bs″−Ys″).

10. The method as claimed in claim 9 characterized in that the first hue value (Phisat″) is determined (33) by means of a red (Rs″), green (Gs″) and blue (Bs″) color component of the predicted saturation-controlled RGB-image signal (Rs″, Gs″, Bs″) and a luminance component (Ys″) of the saturation-controlled first image signal (Ys″, Rs″−Ys″, Bs″−Ys″).

11. The method as claimed in claim 8 characterized in that the second processing stream (25) comprises the steps of:
transforming (21) the second image signal (Y′, R′−Y′, B′−Y′) into a RGB-image signal (R′, G′, B′)
non-linear converting (27) the RGB-image signal (R′, G′, B′) into a predicted RGB-image signal (R″, G″, B″)
re-transforming (29) the predicted RGB-image signal (R″, G″, B″) into a processed second image signal (Y1″, R″−Y″, B1″−Y1″).

12. The method as claimed in claim 11 characterized in that the second hue value (Phiorg″) is determined (31) by means of a red (R″), green (G″) and blue (B″) color component of the predicted RGB-image signal (R″, G″, B″) and a luminance component (Y1″) of the processed second image signal (Y1″, R1″−Y1″, B1″−Y″).

13. The method as claimed in claim 1 characterized in that the corrected hue value (39) is obtained further by means of a linear red (Rs″), green (Gs″) and/or blue (Bs″) color component of the predicted saturation-controlled RGB-image signal (Rs″, Gs″, Bs″) and a linear luminance component (Ys″) of the saturation-controlled first image signal (Ys″, Rs″−Ys″, Bs″−Ys″).

14. The method as claimed in claim 8 characterized in that an output signal (Y″o, (R″−Y″)o, (B″−Y″)o) comprises a hue corrected luminance component (Y″o) and a hue corrected color component ((R′−Y′)o, (B′−Y′)o).

15. The method as claimed in claim 14 characterized in that a display signal is obtained comprising the steps of:
transforming (41) the output signal (Y″o, (R″−Y″)o, (B″−Y″)o) into an output RGB-image signal (Ro″,Go″,Bo″);
non-linear converting (43) the output RGB-image signal (Ro″,Go″,Bo″) into the display signal (Ro′,Go′,Bo′).

16. The method as claimed in claim 9 characterized in that the step of non-linear converting (27, 43) simulates a display transfer-function (gamma) or an inverse display transfer-function (degamma).

17. The method as claimed in claim 16 characterized in that the display transfer-function (gamma) or the inverse display transfer-function (degamma) is adapted to a display selected from the group consisting of: Cathode Ray Tube (CRT), Liquid Crystal Display (LCD), Plasma Display Panel (PDP).

18. The method as claimed in claim 1 characterized in that the hue restoration (20) is applied (FIG. 7) on basis of a before-display transfer function signal.

19. The method as claimed in claim 1 characterized in that the first image signal and the second image signal is formed by the same saturation-controlled image signal (Y′, satx(R′−Y′), satx(B′−Y′)).

20. The method as claimed in claim 19 characterized in that the first processing stream (23) comprises the step of: determining (33) the first hue value (Phinl′) directly from the first image signal.

21. The method as claimed in claim 19 characterized in that the second processing stream (25) comprises the steps of:
transforming (21) the second image signal (Y′, satx(R′−Y′), satx(B′−Y′)) into an RGB-image signal (R′, G′, B′);
providing (45) a limited RGB-image signal (Rsl′, Gsl′, Bsl′) by limiting negative values of the RGB-image signal (R′, G′, B′) to zero;
re-transforming (29) the limited RGB-image signal (Rsl′, Gsl′, Bsl′) into a limited second image signal (Ysl′, Rsl′−Ysl′, Bsl′−Ysl′)

22. The method as claimed in claim 19 characterized in that the second hue value (Philimit′) is determined (31) by means of a red (Rsl′), green (Gsl′) and blue (Bsl′) color component of the limited RGB-image signal (Rsl′, Gsl′, Bsl′) and a luma component (Ysl′) of the limited second image signal (Ysl′, Rsl′−Ysl′, Bsl′−Ysl′).

23. The method as claimed in claim 19 characterized in that the corrected hue value (39) is obtained further by means of a non-linear red (Rsl′), green (Gsl′) and/or blue (Bsl′) color component of the limited RGB-image signal (Rsl′, Gsl′, Bsl′) and a non-linear luma component (Ysl′) of the limited second image signal (Ysl′, Rsl′−Ysl′, Bsl′−Ysl′).

24. The method as claimed in claim 19 characterized in that in the hue restoration (30) the corrected hue value (39) is obtained (FIG. 9) further by means of the non-linear chroma component (satx(R′−Y′), satx(B′−Y′)) of the saturation-controlled image signal (Y′, satx(R′−Y′), satx(B′−Y′)).

25. The method as claimed in claim 19 characterized in that the output signal (Y′o, (R′−Y′)o, (B′−Y′)o) is obtained by directly using a lightness component (Y′) of the input image signal (Y′, R′−Y′, B′−Y′), and a hue corrected non-linear color component ((R′−Y′)o, (B′−Y′)o).

26. The method as claimed in claim 19 characterized in that a display signal is obtained in form of the output signal (Y′o, (R′−Y′)o, (B′−Y′)o).

27. The method as claimed in claim 1 characterized in that in particular to prevent divider problems upon processing the step of hue restoration (40) is completed (FIG. 10) as a function of a threshold level (RGBmax″-RGBmin″) of a value of a red, green or blue color component of a RGB-image signal (R′, G′, B′).

28. An image signal processing device (FIGS. 4, 7, 9, 10) for controlling a color saturation for an image, said device comprising:
means for providing an input image signal (Y′, R′−Y′, B′−Y′); means for applying a saturation control (17) to the input image signal resulting in a saturation-controlled image signal (Y′, satx(R′−Y′), satx(B′−Y′)); wherein
a hue restoration unit (10, 20, 30, 40) is adapted to process a saturation-controlled image signal (Y′, satx(R′−Y′), satx(B′−Y′)), the unit comprising:
means (33) for determining a first hue value (Phisat″, Phinl′) from a first image signal in a first processing stream (23), and
means (31) for determining a second hue value (Phiorg″, Philimit′) from a second image signal in a second processing stream (25);
means (35) for obtaining a corrected hue value (39) from the first hue value (Phisat″, Phinl′) and/or the second hue value (Phiorg″, Philimit′);
means (41, 43) for obtaining an output signal (Y″o, (R″−Y″)o, (B″−Y″)o/Y′o, (R′−Y′)o, (B′−Y′)o) based on the corrected hue value (39).

29. Apparatus (3) comprising a display means (11) and an image signal processing device (FIGS. 4, 7, 9, 10) wherein the image signal processing device is adapted to perform the method according to claim 1.

30. Apparatus (3) of claim 29 comprising a display means (11) selected from the group consisting of: Cathode Ray Tube (CRT), Liquid Crystal Display (LCD), Plasma Display Panel (PDP).

31. A computer program product storable on a medium readable by a computing device comprising a software code section which induces the computing device to execute the method as claimed in claim 1 when the product is executed on the computing device.

32. A computing and/or storage device for executing and/or storing the computer program product as claimed in claim 31.
